(19) United States
(12) Patent Application Publication
(10) Pub. No.: US 2009/0150299 A1
(43) Pub. Date: Jun. 11, 2009

(54) TRANSACTION SYSTEM

(76) Inventors: Mark Moscal, Covina, CA (US); Robert Fair, North Tustin, CA (US); Mark Bellegia, Diamond Bar, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/369,597

(22) Filed: Feb. 11, 2009

Related U.S. Application Data
(63) Continuation of application No. 11/895,241, filed on Aug. 22, 2007, now abandoned.
(60) Provisional application No. 60/823,209, filed on Aug. 22, 2006.

(51) Int. Cl. G06Q 30/00

(52) U.S. Cl. 705/80; 705/35

(57) ABSTRACT

Transaction systems are disclosed that enable a customer to obtain services from a service provider via any of a variety of communication systems on a direct fee basis. The transaction system can be independent of the communication system used to complete the transaction and the billing system used to provide payment from the customer to the service provider. In many embodiments, the transaction system arranges direct payment from the customer to the service provider. One embodiment of the invention includes a transaction metering system connected to a service provider computing device and a client computing device via a first communication network. In addition, the service provider computing device and the client computing device are connected via a second communication network, the service provider computing device and the client computing device are configured to negotiate terms for the completion of a transaction by exchanging messages over the first communication network via the transaction metering system, the service provider computing device and the client computing device are configured to conduct a communication session via the second communication network and the transaction metering system is configured to meter a transaction conducted during a communication session.

### CROSS-REFERENCE TO RELATED APPLICATIONS

This application is a continuation of application Ser. No. 11/895,241 filed Aug. 22, 2007, which claims priority to U.S. Provisional Application Ser. No. 60/823,209 entitled “Proxy Billing System” to Moscal et al., filed Aug. 22, 2006, the disclosure of which is expressly incorporated by reference herein in its entirety.

### BACKGROUND

The present invention relates generally to transaction systems and more specifically to transaction systems that enable the monetization of services provided using a communication system.

The increasing array of options with which people can communicate with each other presents new opportunities for service providers to provide services to customers. A service provider can now provide services during a call using a traditional telephone, a call using a digital mobile phone, a call using a VolP telephone, and/or a video conference call. A service provider can also provide services via E-mail, Instant Messaging, SMS messaging and/or MMS messaging. When providing services, a service provider will often charge customers based upon the amount of time spent working on the customer's behalf. The administrative overhead associated with entering customer information into an accounting system, recording time entries for services provided, billing the customer and collecting a payment can considerably reduce the financial benefit to a service provider of performing work on the customer's behalf.

A number of systems have been developed to automate tracking and billing for services provided via a communication technology. For example, U.S. Patent Publication 2003/0187800 to Alandros et al. describes a billing system that can be used to determine charges associated with use of services. Other examples include the systems described in U.S. Patent Publication 2004/0062370 to O'Neal et al., U.S. Patent Publication 2004/0032936 to Horel et al. and U.S. Patent Publication 2006/0153351 to Hartung et al. The disclosure of U.S. Patent Publications 2003/0187800, 2004/0062370, 2004/0032936 and 2006/0153351 is incorporated by reference herein in its entirety.

### SUMMARY OF THE INVENTION

Systems and methods for utilizing existing communications systems to provide services are disclosed. In many embodiments, a transaction system enables a service provider and a customer to negotiate terms of service, verify customer billing information, initiate a session using the existing communication system, meter the session, initiate payment based upon the duration of the session, and/or store a record of the transaction. In many embodiments, a modular system is provided that enables selection of the functions helpful for supporting the provision of services in a particular application.

One embodiment of the invention includes a transaction metering system connected to a service provider computing device and a client computing device via a first communication network. In addition, the service provider computing device and the client computing device are connected via a second communication network, the service provider computing device and the client computing device are configured to negotiate terms for the completion of a transaction by exchanging messages over the first communication network via the transaction metering system, the service provider computing device and the client computing device are configured to conduct a communication session via the second communication network and the transaction metering system is configured to meter a transaction conducted during a communication session.

In a further embodiment, the service provider computing device and the customer computing device are personal computers including appropriately configured client applications.

In another embodiment, the service provider computing device and the customer computing device are devices configured using appropriate web browsing applications.

In a still further embodiment, the first communication network includes the Internet.

In still another embodiment, the second communication network includes the Internet.

In a yet further embodiment, the second communication network is an Instant Messaging network, a Voice over Internet Protocol network or a video conferencing network.

In yet another embodiment, the second communication network is the public switched telephone network.

In a further embodiment again, the second communication network is a mobile telephone network.

In another embodiment again, the transaction metering system is configured to initiate a communication session between the service provider computing device and the customer computing device.

In a further additional embodiment, the customer computing device is configured to send a signal to the transaction metering system indicative of the commencement of a transaction and the transaction metering system is configured to commence metering the transaction in response to receipt of the signal from the customer computing device.

In another additional embodiment, the customer computing device is configured to provide billing information to the transaction metering system and the transaction metering system is configured to verify the billing information.

In a still yet further embodiment, the transaction metering system is configured to provide at least some of the billing information to a billing system and the billing system is configured to verify the billing information and provide verification information to the transaction metering system.

In still yet another embodiment, the billing system is operated independently of the transaction metering system and the billing system and transaction metering system are connected via a public network.

In a still further embodiment again, the billing system and transaction metering system are connected via a private network.

In still another embodiment again, the transaction metering system is configured to generate a risk report including at least some of the verification information.

In a still further additional embodiment, the transaction metering system is configured to generate an image that graphically illustrates the risk of proceeding with a transaction.

In still another additional embodiment, the transaction metering system is configured to provide at least one payment option to the customer computing device, the customer computing device is configured to communicate a payment option selection and billing information appropriate to the payment option selection to the transaction metering system, the transaction metering system is configured to determine a transaction fee based on the negotiated terms and the metered duration of the transaction, the transaction metering system is configured to provide the transaction fee and the billing information to a billing system and the billing system is configured to perform a funds transfer in the amount of the transaction fee in the manner indicated by the selected payment option.

In a yet further embodiment again, the transaction metering system is configured to generate a transaction record.

In yet another embodiment again, the transaction metering system is configured to store the transaction record in a database.

In a yet further additional embodiment, the transaction metering system is configured to send copies of the transaction record to the customer computer and to the service provider computer.

An embodiment of the method of the invention includes logging into a server, negotiating terms of service by transferring messages via the server, providing billing information to the server, verifying the billing information, initiating the metering of the transaction by providing a message to the server, stopping the metering of the transaction by providing a message to the server, performing a funds transfer for an amount determined in accordance with the terms of service and the metered time of the transaction and using the billing information, generating a record of the transaction, distributing the record to the parties to the transaction and storing a copy of the transaction.

A further embodiment of the method of the invention also includes displaying risk information and accepting the risk of the transaction by communicating an instruction to proceed to the server.

Another embodiment of the method of the invention also includes initiating a communication session involving exchange of data via a second server that is independent of the first server.

Another further embodiment of the invention includes a server configured to connect to a network. In addition, the server is configured to receive messages concerning terms of service via the network connection, the server is configured to forward messages concerning terms of service via the network connection, the server is configured to receive messages accepting terms of service via the network connection, the server is configured to provide information concerning payment options via the network connection, the server is configured to receive a message including the selection of a payment option via the network connection, the server is configured to receive a message containing payment information via the network connection, the server is configured to validate at least some of the payment information, the server is configured to forward at least some of the payment information to a billing system, the server is configured to receive a message including validation information from the billing system, the server is configured to provide validation information via the network connection, the server is configured to receive a message authorizing proceeding with the transaction via the network connection, the server is configured to receive a message authorizing metering of the transaction via the network connection, the server is configured to provide information concerning the meter via the network connection, the server is configured to receive a message including instructions to stop the meter via the network connection, the server is configured to calculate a transaction fee, the server is configured to send a message containing the transaction fee and at least some of the billing information to the billing system, the server is configured to generate a transaction record and the server is configured to provide the transaction record via the network connection.

### BRIEF DESCRIPTION OF DRAWINGS

FIG. 1 is a schematic network diagram of transaction system in accordance with an embodiment of the invention.

FIG. 2 is a flow chart illustrating a process for conducting a transaction in accordance with an embodiment of the invention.

FIG. 3 is a flow chart showing processes performed by a customer client application during a transaction in accordance with an embodiment of the invention.

FIG. 4 is a flow chart showing processes performed by a service provider client application during a transaction in accordance with an embodiment of the invention.

FIG. 5 is a flow chart showing processes performed by a transaction metering system server application during a transaction in accordance with an embodiment of the invention.

FIG. 5A is a screen shot of a billing information risk report in accordance with an embodiment of the invention.

FIG. 6 is a flow chart showing a process that can be used to login to a transaction metering system in accordance with an embodiment of the invention.

FIG. 7 is a flow chart showing a process for negotiating the terms of a transaction in accordance with an embodiment of the invention.

FIG. 8 is a flow chart showing a process for obtaining billing information in accordance with an embodiment of the invention.

FIG. 9 is a flow chart showing a process for conducting a communication session and providing payment for services during the communication session in accordance with an embodiment of the invention.

FIG. 10 is a schematic network diagram of a transaction system that utilizes two separate communication networks in accordance with an embodiment of the invention.

FIG. 11 is a schematic network diagram of a transaction system that includes a transaction metering system, a billing system and a communication system provided by a single entity.

### DETAILED DESCRIPTION OF THE INVENTION

Turning now to the drawings, systems and methods for creating a transaction system are shown. In a number of embodiments, the transaction system can facilitate the negotiation of terms of service between a service provider and a customer. Once terms have been agreed upon, the transaction system can provide the service provider with assurance of the customer's ability to pay by verifying billing information provided by the customer. In several embodiments, the transaction system can meter a session during which a service provider provides services to the customer. The services are typically provided using an existing communication system distinct from the transaction system, but can be provided using a communication system integrated with the transaction system. Once the session is completed, transaction systems in accordance with a number of embodiments of the invention coordinate the direct transfer of funds from the customer to the service provider and store a record of the transaction in a database for subsequent retrieval. In several embodiments, the services are provided on a one-to-one basis. In many embodiments, the services are provided on a one-to-many basis. A feature of a number of embodiments of the invention is that the transaction system is constructed from one or more software modules that provide the various functions desired by a service provider to support transactions.

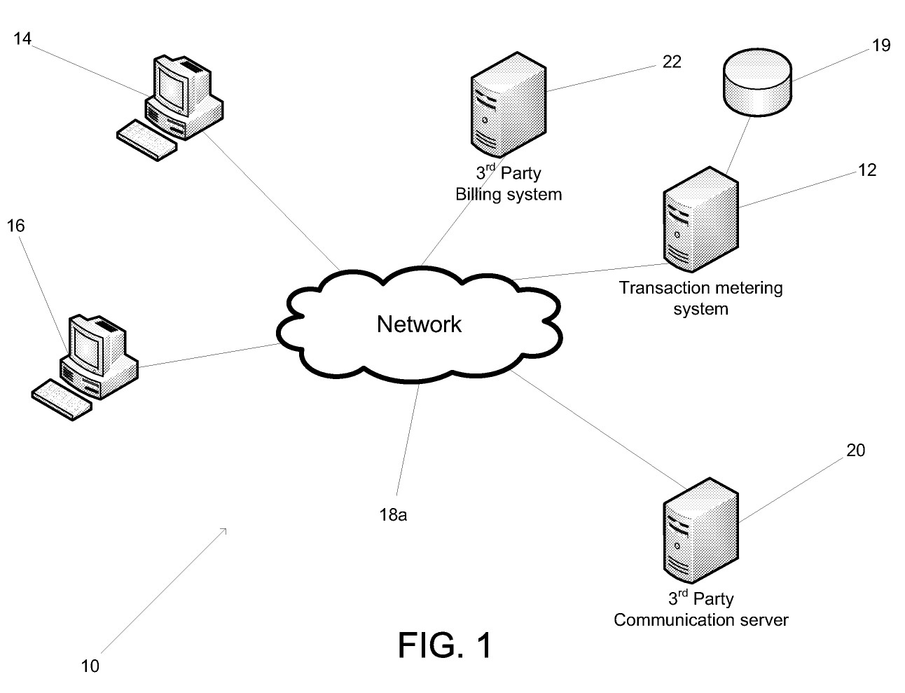

A transaction system in accordance with an embodiment of the invention is shown in FIG. 1. The transaction system 10 includes a transaction metering system 12 that is connected to a service provider computer 14 and a customer computer 16 via a network 18. The transaction metering system is also connected to a database 19. The transaction metering system 12, service provider computer 14, and the customer computer 16 are all capable of connecting with a communication server 20 via the network 18. The transaction metering system 12, service provider computer 14, and the customer computer 16 are also capable of connecting with a billing system 22 via the network 18.

In the illustrated embodiment, the service provider computer 14 includes a client application that enables the service provider computer to login to a server application hosted on the transaction metering system 12. A similar client application located on the customer computer 16 enables the customer computer to login to the server application on the transaction metering system. The server application coordinates communication between the client applications on the service provider computer and the customer computer. In other embodiments, the service provider computer and or the customer computer can communicate with the transaction metering system via a web application.

In many embodiments, a customer can use the customer computer to approach a service provider. The customer computer sends a message to the transaction metering system and the transaction metering system alerts the service provider computer of the customer computer's request. In other embodiments, the customer contacts the service provider directly and then the service provider and customer login to the transaction metering system.

Once a service provider has been contacted, the transaction metering system handles the negotiation of terms of service between the service provider and the customer. In many embodiments, the terms of service are fixed and the customer simply has the choice of accepting or rejecting the terms of service. In several embodiments, the transaction metering system handles communication between the service provider and the customer that enable the service provider and the customer to reach an agreement concerning terms for providing services. When the terms of service are negotiated, the transaction metering system can obtain confirmation from both the service provider and the customer of agreement to the terms of service. In other embodiments, the negotiations can be handled separately from the transaction metering system and, once the negotiations are complete, the service provider can simply offer the services via the transaction metering system on an accept or decline basis.

In addition to establishing terms of service, the transaction metering system can coordinate payment. In a number of embodiments, the service provider can specify one or more acceptable methods of payment. The customer can choose one of the payment methods and provide the transaction metering system with the billing information required to process a payment from the customer to the service provider's merchant account. Examples of methods can include use of the service provided by Paypal, which is a company owned by E-Bay, Inc. of San Jose, Calif., payment via Credit Card and/or payment via electronic check. In many embodiments, payment is coordinated by the transaction metering system using a 3^{rd} party payment processing system. In several embodiments, the transaction metering system uses billing information provided by a customer to perform a risk analysis for the service provider. A risk analysis typically involves a determination of the customer's ability to pay. Depending upon the outcome of the risk analysis, the service provider can decide whether to proceed with the provision of services, request a more secure form of payment or terminate the transaction.

Many transactions performed using transaction systems in accordance with embodiments of the invention involve payment based upon the amount of time required to complete the transaction between the service provider and the customer. Once the service provider and the customer have established communication, service provider and/or customer can request that the transaction metering system start a timer that will determine the time based fee charged to the customer. A service provider can conduct multiple metered sessions simultaneously. Each session has a separate meter and both the service provider and the customer have the ability to toll the meter. In this way, a service provider can move between sessions starting and stopping the meters as the service provider addresses different transactions. In other embodiments, the service provider can provide services on a flat fee basis. In embodiments where flat fees are charged for particular tasks, the transaction metering system can log tasks performed by the service provider.

As discussed above, a transaction metering system in accordance with an embodiment of the invention is typically used in conjunction with the provision of services via a communication system. Any communication system can be used and the extent of the cooperation between the transaction metering system and the communication system typically depends upon the application. In a number of embodiments, the communication system is entirely separate from the transaction metering system. In these embodiments, the transaction metering system handles the financial side of the transaction and the actual transaction is performed using the communication system. Examples of communication systems that operate entirely independently of the transaction metering system include, but are not limited to, Instant Messaging services (such as AIM provided by AOL, LLC of Dulles, Va.), telephone services (POTS, mobile and VoIP) and video conferencing technologies (such as the iChat application distributed by Apple, Inc. of Cupertino, Calif. and the Skype application distributed provided by Skype, which is a division of E-Bay, Inc. of San Jose, Calif.). In many embodiments, the communication system is provided by a 3^{rd} party, however, the transaction metering system plays a role in establishing communication between the service provider and the customer. Examples of such systems include, but are not limited to, the transaction metering system providing a conference call in number that can be used by the service provider and one or more customers, and the transaction metering system establishing a telephone connection between the service provider and the customer using double blind calls initiated by the transaction metering system. In several embodiments, the transaction metering system also includes an integrated communication system.

In the illustrated embodiment, the service provider computer and the customer computer are configured to enable communication via a communication server. In one embodiment, the communication server enables Instant Messaging between the service provider computer and the customer computer. In another embodiment, the communication server enables audio communication between the service provider computer and the customer computer via a VolP connection. In a further embodiment, the communication server enables audio and video communication between a service provider computer equipped with a video camera and microphone and/or a customer computer equipped with a video camera and microphone.

When the transaction is complete, the transaction metering system determines the amount to charge the customer based upon the negotiated terms of service. The transaction metering system can then use the billing information provided by the customer to initiate a transfer of funds from the customer to the service provider's merchant account. In many embodiments, a 3^{rd} party billing system handles the transaction and the funds pass directly from the customer to the service provider's merchant account. In other embodiments, the transaction metering system includes a billing system the transaction metering system is directly responsible for the transfer of funds from the customer to the service provider's merchant account. In the illustrated embodiment, a third party billing system 22 handles payment.

In addition to handling payment, the transaction metering system 12 creates a record of the transaction. The transaction metering system can provide the transaction record to the service provider computer and/or the customer computer. In addition, the transaction metering system stores the transaction record in the database 19 for subsequent audit.

Although the computer and systems shown in FIG. 1 communicate via the same network, in many embodiments a variety of networks are used to exchange information between the various computers and systems. In addition, a service provider computer and/or a customer computer need not be a personal computer. The service provider computer and/or the customer computer can be an appropriately configured mobile phone or consumer electronics device. In many embodiments, the devices included in the transaction system depend upon the environment in which the application system operates and the service providers that utilize the transaction system.

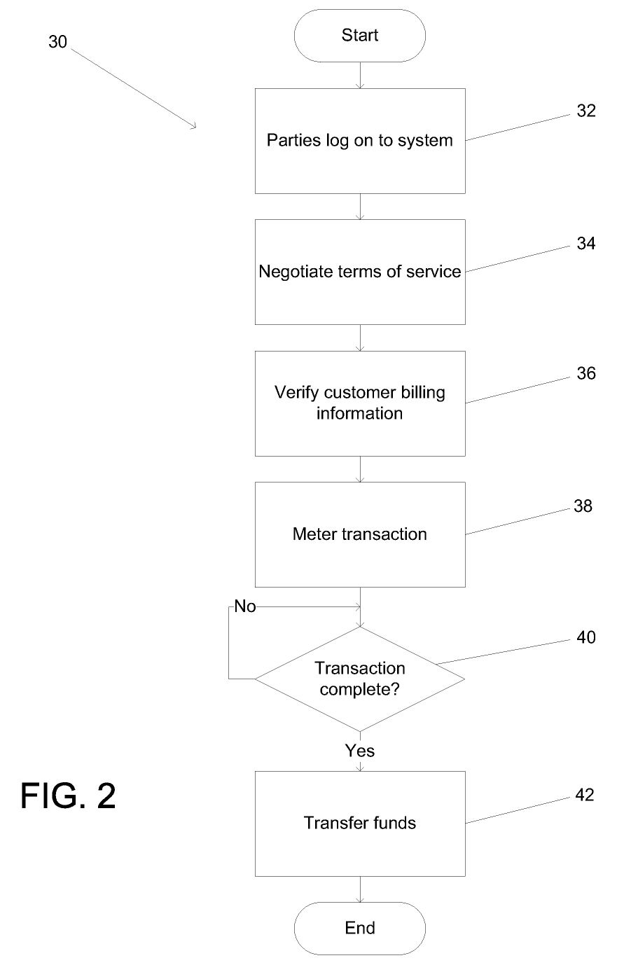

A process for conducting a metered transaction in accordance with an embodiment of the invention is shown in FIG. 2. The process 30 commences when both the service provider and the customer have logged on (32) to the transaction system. The service provider and the customer negotiate (34) the terms of service and then the customer provides billing information that is then verified (36). Once the billing information has been verified, the transaction can commence. The transaction is metered (38) and when a determination (40) is made that the transaction is complete, the negotiated fee is transferred (42) from the customer to the service provider. In a number of embodiments, the transfer of funds is accompanied by the creation of a transaction record that is provided to the service provider and/or customer and which is stored for subsequent retrieval. In many embodiments, the transaction does not require the performance of all of the operations illustrated in FIG. 2. In these embodiments, a modular transaction system can be utilized to perform only the required operations. For example, a transaction may only require metering and billing or only require production of a transaction record.

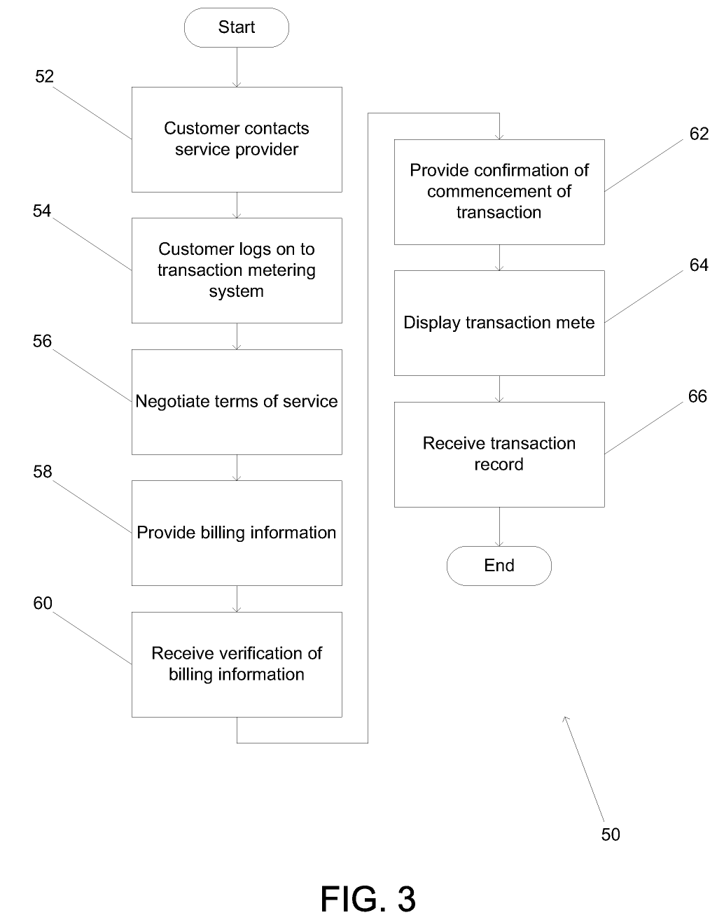

As discussed above, transaction systems in accordance with a number of embodiments of the invention utilize a client server model. Functions performed by a customer client, a service provider client and a server during a transaction are illustrated in FIGS. 3-5.

A process performed by a customer client application in accordance with an embodiment of the invention is shown in FIG. 3. The process 50 commences when the customer contacts (52) a service provider. In a number of embodiments, the contact is performed via a link (such as a URL) on a 3^{rd} party website or in a 3^{rd} party directory that causes the launch of the customer client application or a web based customer application. In other embodiments, a directory of service providers is maintained in the client application. In other embodiments, the customer makes initial contact using another communication means and the service provider gives the customer connection information. At some point, the customer logs in (54) to a transaction metering system server using the customer client application. Once the customer is logged in, the customer is able to negotiate (56) terms of service with the service provider using the customer client application and provide (58) billing information to the transaction metering system server. The transaction metering system server performs verification of the billing information and, assuming the billing information is correct, the customer client application receives confirmation (60) that the billing information has been verified.

Once the terms of service are established and verification of the customer's billing information has been obtained, the transaction can commence. In many embodiments, the customer client application includes a user interface enabling the customer to provide an input (for example, pressing a “start matter” button) to indicate (62) that the transaction has commenced. Upon receipt of the appropriate indication from the customer, the customer client application notifies the transaction metering server of the commencement of the transaction. In embodiments where the transaction metering server provides or coordinates the communication system used to conduct the transaction, transaction metering can be automatically commenced by the transaction metering server. When the appropriate indication has been received, a transaction meter maintained by a transaction metering server can be displayed (64) by the customer client application.

Upon completion of the transaction, a transaction record is received (66) by the client application from the transaction metering server. The transaction record typically contains details of the service provider, the terms of the transaction, the duration of the transaction and confirmation of the transfer of funds from the customer to the service provider.

Although a specific process is shown in FIG. 3, other processes in accordance with embodiments of the invention can be used by a customer client application in order to conduct a transaction. In many embodiments, the particular process used depends upon the extent to which the transaction metering server coordinates the communication system used to conduct the transaction. In addition, similar processes can be used by web based applications to enable customers to conduct transactions without a client software application resident on a customer computing device.

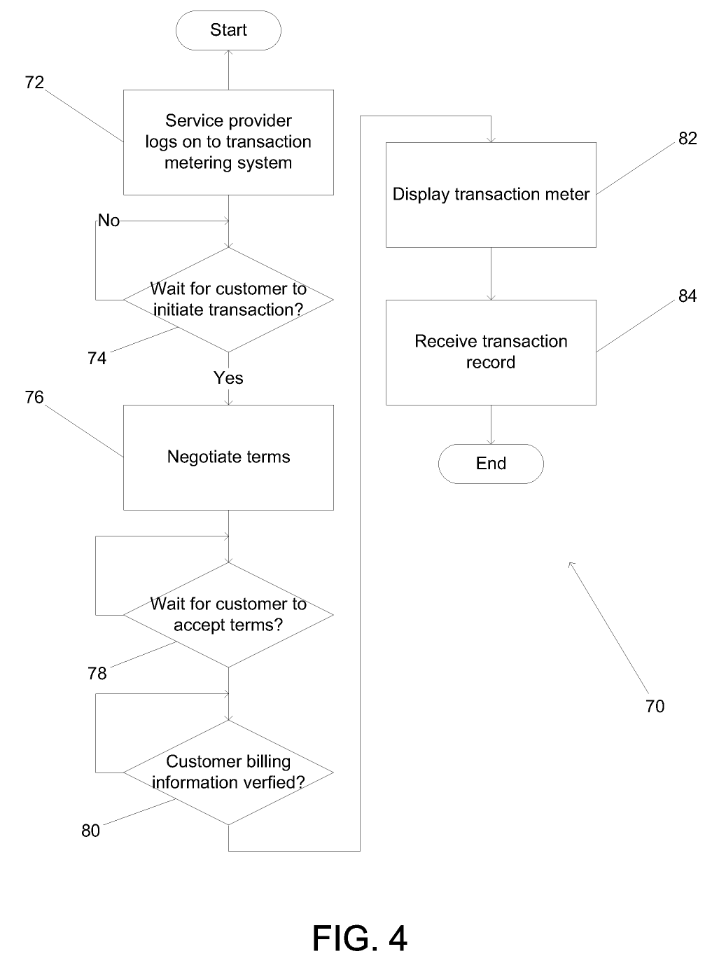

A process used by a service provider client application to conduct a transaction in accordance with an embodiment of the invention is shown in FIG. 4. The process 70 commences when the service provider logs in (72) to a transaction metering system server using a service provider client application. Once logged in, the service provider client application waits for a message from the transaction metering system server indicating that a customer wishes to initiate a transaction. When the service provider client application determines (74) that a message indicating a customer wishes to initiate a transaction has been received, the service provider can use the service provider client application to negotiate (76) terms of service with the client via the transaction metering system. When the service provider client application determines (78) that the client has accepted the terms of service, the service provider waits until a determination (80) has been made that the customer's billing information has been verified. If the service provider receives notification that the customer's billing information could not be verified or the service provider's client times out, then the service provider's client terminates the transaction. In a number of embodiments, the verification information includes information related to the risk of accepting payment from a customer. The service provider can review the risk information and make a determination concerning whether to proceed with the transaction.

Typically, the customer commences the transaction and a meter is displayed (82) by the service provider client application. Upon completion of the transaction, the service provider client application receives (84) a transaction record from the transaction metering system server. In a number of embodiments, the service provider client application also notifies the service provider when funds have been posted to the service provider's merchant account.

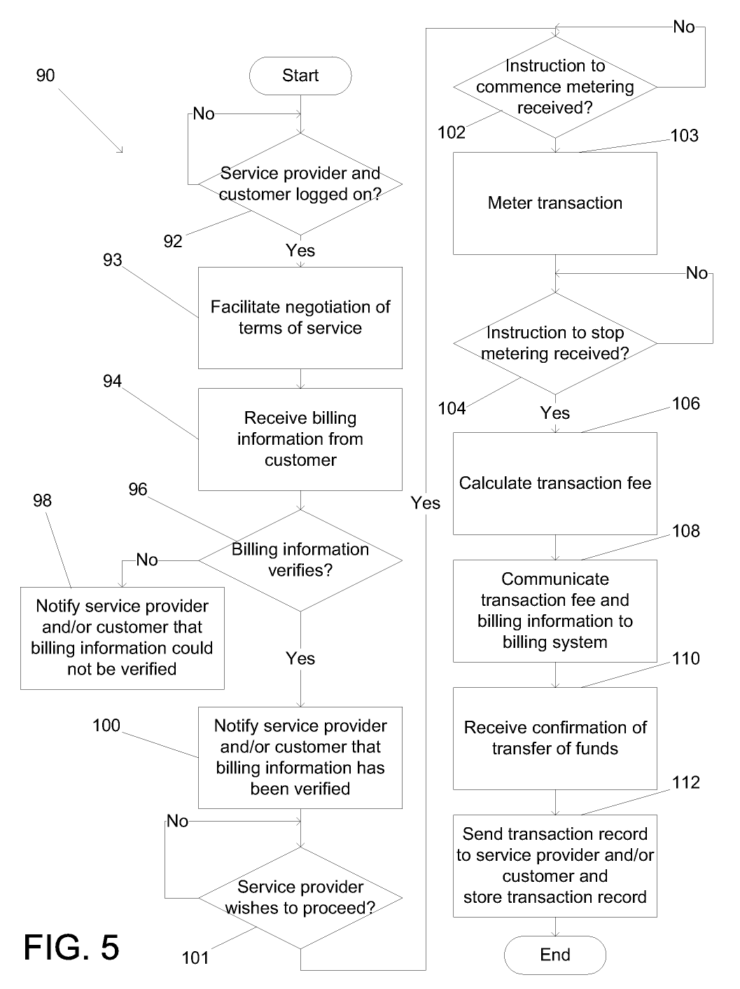

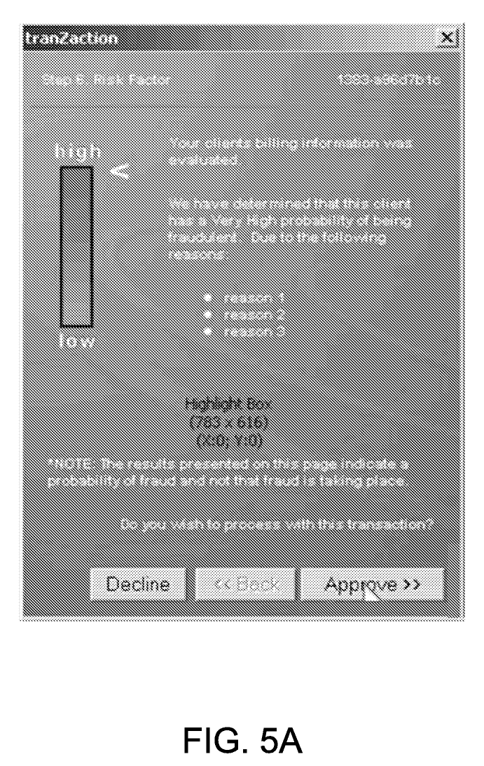

A process used by a transaction metering system server application to perform a transaction in accordance with an embodiment of the invention is shown in FIG. 5. The process 90 includes, waiting (92) for the service provider and the customer to log in to the server application. Once both the service provider and the customer have logged in, the exchange of information between the service provider and the customer associated the negotiation of terms of service is handled (93) until a set of terms is agreed upon. The transaction metering system server receives (94) billing information from the customer and determines (96) whether the billing information meets an initial verification test. In a number of embodiments, the transaction metering system server simply determines whether the billing information matches specified data formats. In other embodiments, more thorough verification steps are performed including providing the billing information to a 3^{rd} party billing system for verification. When the billing information fails the verification test, the system notifies (98) the customer and can request that the customer reenter the billing information. When the billing information verifies, the transaction metering server application notifies (100) the service provider that the customer's billing information has been verified. In embodiments where the verification process includes the generation of a risk report, the transaction metering server application can also provide the service provider with at least some of the information within the risk report. A screen shot showing a risk report including a graphical representation of the risk in accordance with embodiment of the invention is shown in FIG. 5A. The transaction system waits (101) for confirmation that the service provider is willing to proceed with the transaction. Upon receipt of confirmation, the transaction can commence and the transaction metering server application then waits (102) to receive an instruction that the transaction has commenced. The customer typically provides the instruction that the transaction has commenced. In many embodiments, however, instructions must be received from both the service provider and the customer or instructions can be received from the service provider.

Upon receipt of an instruction that the transaction has commenced, a meter beings to run (103) that meters the transaction. In embodiments where the transaction does not involve payment of a fee based upon the duration of the transaction, the transaction metering system server application simply records the occurrence of the transaction. The meter runs until a determination (104) is made that the transaction is complete. In many embodiments, both the service provider and the customer possess the ability to end a transaction. Upon completion of the transaction, the fee charged to the customer is calculated (106). The fee and the billing information are then provided to a billing system for processing of the payment from the customer to the service provider. As discussed above, many embodiments of the invention rely upon a 3^{rd} party billing system to complete the transfer of funds. Once payment has been initiated, the transaction metering system server application can provide a transaction record to the service provider and/or customer. The transaction metering system server application will also typically store a copy of the transaction record in a database for subsequent retrieval.

The processes shown above in FIGS. 2-5 include various functions performed by customer client applications, service provider client applications and transaction metering system server applications in accordance with embodiments of the invention. These functions can be performed by other applications within the system. In many embodiments, the client server architecture can be replaced with another architecture. For example, several embodiments of transaction systems are implemented using a web server that hosts an interactive web site that can be accessed by computing devices configured using appropriate web browsing applications. When web based applications are used, the service provider and customer computing devices receive web pages in which data can be entered. The web server (or another server) receives the data, processes the data and generates new web pages in response to the received data in a way that implements the functionality described above.

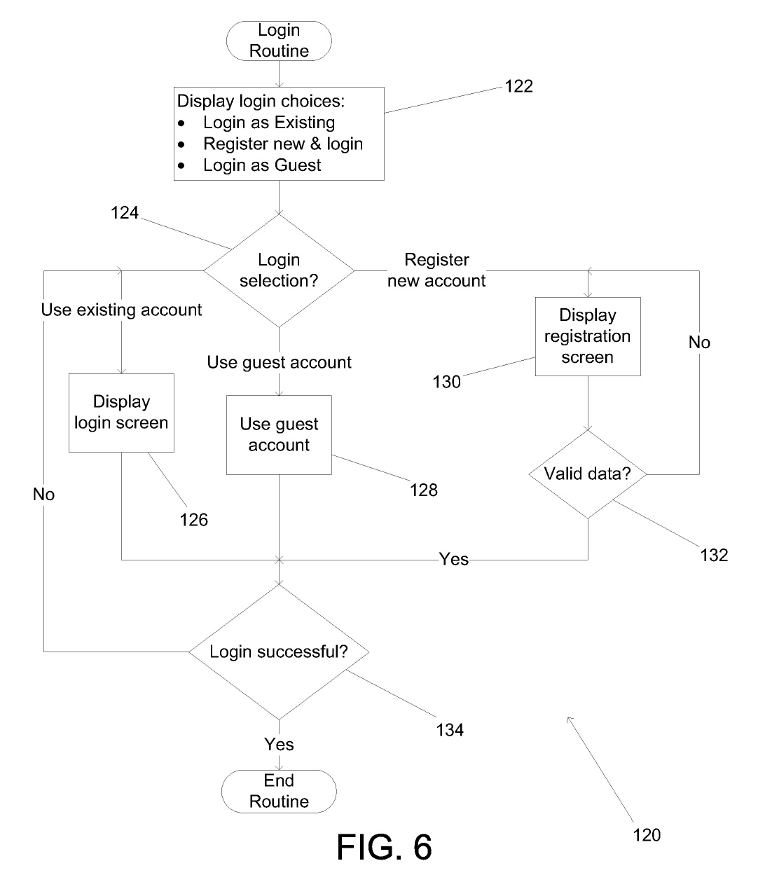

As can be appreciated from the above discussion, the customer determines much of the manner in which a transaction is conducted. Routines that can be used in a modular fashion to construct an appropriate customer client application in accordance with an embodiment of the invention are shown in FIGS. 6-9.

A process that can be used to login to a transaction metering system in accordance with an embodiment of the invention is shown in FIG. 6. The process 120 includes displaying (122) a number of login options including logging in using an existing account, logging in using a guest account or creating a new account. A determination (124) is then made concerning the customer's response. When the customer selects logging in using an existing account, a login screen is displayed (126) in which a customer can enter login information. When the customer selects logging in using a guest account, the desire to register as a guest is provided (128) to the transaction metering system. When the customer decides to create a new account, a registration screen is displayed (130) containing a registration form, which the customer must complete. A determination (132) is made concerning whether the registration information entered by the customer is valid. In the event the information is invalid, the customer is prompted to correct the errors. Once valid information has been received, the information is used to create an account.

Irrespective of the manner in which the customer elects to login to the transaction metering system, a verification of the customer's login information is performed (134). Assuming the login information is correct, the customer is logged into the transaction metering system and the process completes. In many embodiments, entry of incorrect login information results in the user being prompted to reenter the login information. In several embodiments, a customer must login to the system and a predetermined number of incorrect login attempts will result in the customer being locked out of the system for a predetermined period of time.

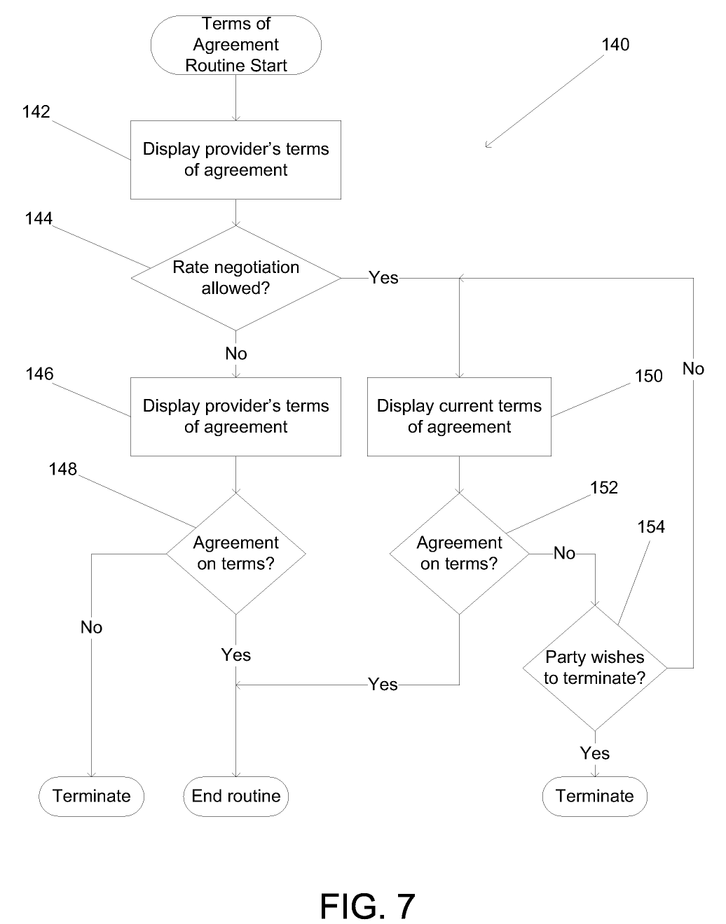

A process for negotiating the terms of a transaction in accordance with an embodiment of the invention is shown in FIG. 7. The process 140 includes displaying (142) a service provider's initial set of terms and conditions. A determination (144) is made concerning whether the service provider allows rate negotiation. In the event the service provider does not allow negotiation, the service provider's terms are displayed (146) and the customer is provided with the choice (148) of whether to accept the terms. When the customer accepts the terms, the process is complete and the terms of service have been established. When the customer rejects the terms, the transaction terminates.

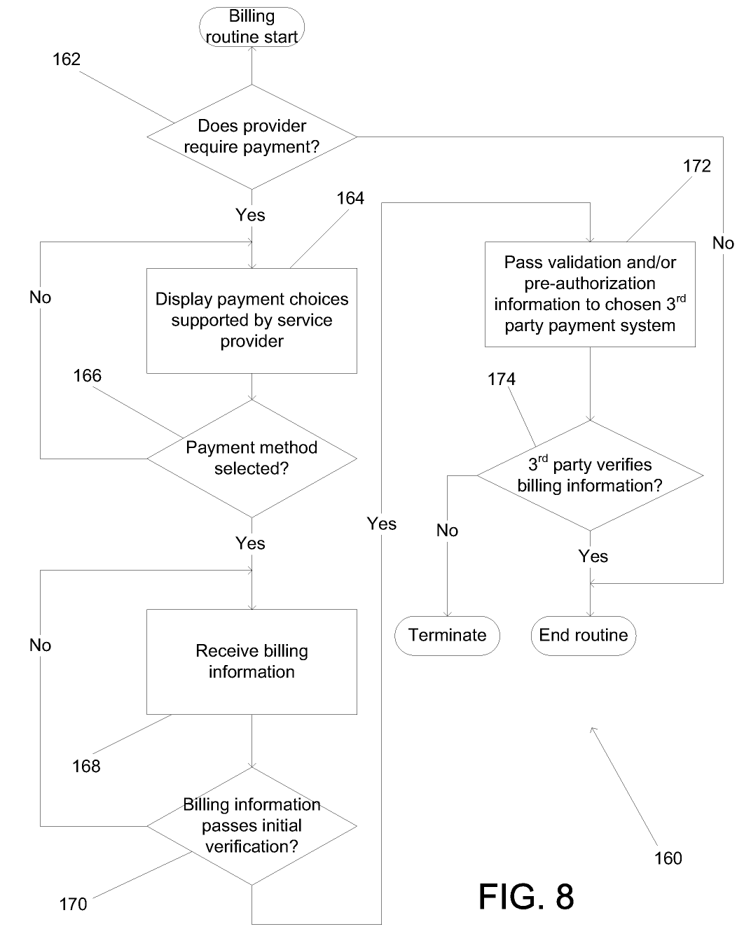

In the event the service provider does entertain negotiation of terms, the service provider's initial terms are displayed (150) and the customer is given the opportunity to provide an alternative proposal. Both parties can continue to negotiate terms until agreement is reached (152). At any point, either party can terminate (154) the transaction. Once agreement is reached, the process is complete and the terms of service have been established. A process for obtaining billing information in accordance with an embodiment of the invention is shown in FIG. 8. The process 160 includes determining (162) whether the service provider requires payment. When a service provider does not require payment, no billing information is required and the process ends. When the service provider requires payment, the payment options that are acceptable to the service provider are displayed (164) and the customer can select (166) one of the options. Once a payment method has been selected, billing information appropriate to the payment method is obtained. In a number of embodiments, the customer provides (168) billing information and an initial verification of the billing information is performed. The initial verification typically confirms that the appropriate information has been entered in the appropriate formats. When the billing information is incomplete or has been incorrectly entered, the customer is prompted to reenter the billing information. When the billing information passes (170) the initial verification, the billing information is often provided (172) to a 3^{rd} party billing system for verification (174) of the customer's ability to pay in accordance with the terms of the transaction. In many embodiments the 3^{rd} party billing system also provides information that can be used to generate a risk report. The risk report highlights factors that might contribute to a customer's inability to pay a service provider in accordance with the agreed transaction terms. When verification is obtained, the transaction metering system has the information required to arrange payment from the customer to the service provider and the process completes. In one embodiment, a merchant bank provides address verification information about the cardholder. An incorrect street address caused by a customer forgetting to include an apartment number is usually not an indicator of fraud. However, an incorrect street address combined with an incorrect zip code is indicative of an increased likelihood of fraud. In several embodiments, 3^{rd} party information is combined with internal systems, such as customer feedback rating, to allow the system to calculate a score of potential risk for the customer transaction. The service provider is presented with a graphical display of the risk assessment score and given the option to proceed or decline the customer session.

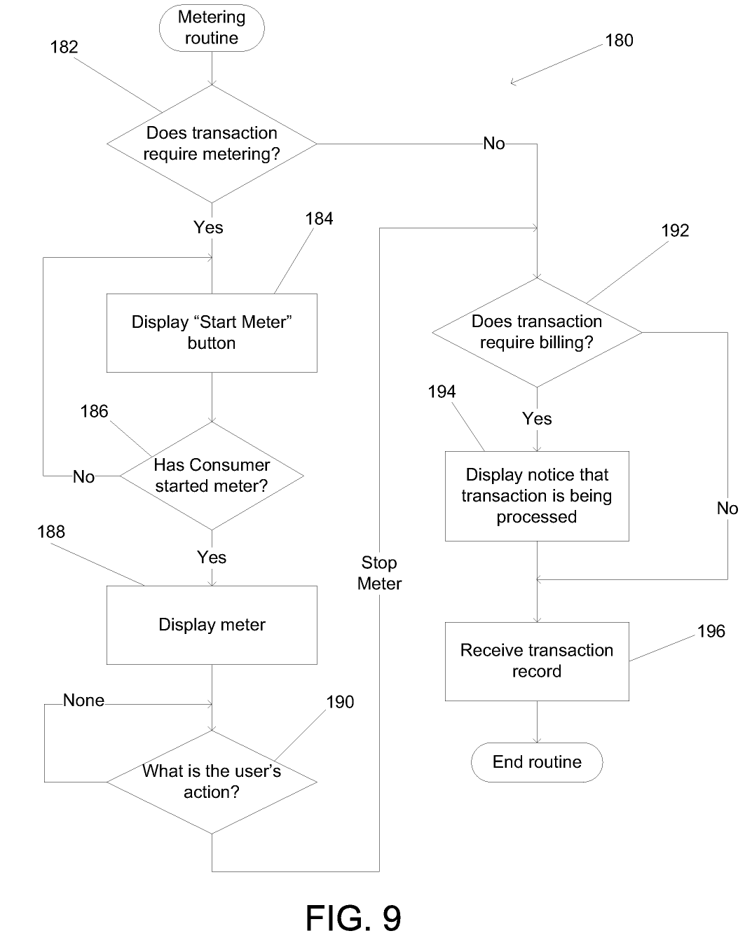

A process for conducting a communication session and providing payment for services provided during the communication session in accordance with an embodiment of the invention is shown in FIG. 9. The process 180 includes determining (182) whether the terms of service require metering of the transaction. When the terms of service do not require metering, then the customer is simply billed a flat rate for the provision of services (see discussion of billing below). When the terms of service require metering, a “start meter” button (or similar) is displayed (184) as part of a user interface provided to the customer. The process waits (186) until the customer starts the meter, at which point the meter starts to run and the meter is displayed (188) to the customer. The meter runs until either the customer or the service provider stops (190) the meter. At which point, a determination (192) is made as to whether the terms of the transaction involve the billing of a charge to the customer. In many embodiments, the duration of the transaction is recorded to provide a record of the transaction and no payment is required. When payment is required, a display indicating that payment is being processed in accordance with the selected payment method is provided (194) to the customer and a transaction record is created and provided (196) to the customer. When no payment is required, the customer is often still provided (196) with a transaction record.

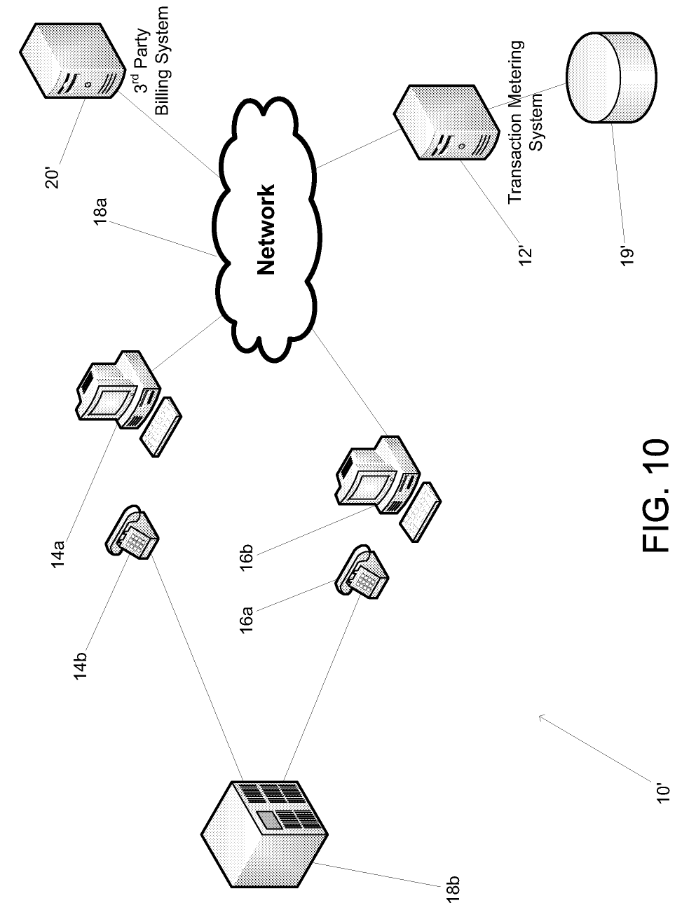

The above discussion makes reference to the use of transaction metering systems in accordance with embodiments of the invention in conjunction with communication systems provided by 3^{rd} parties. In the embodiment illustrated in FIG. 1, the 3^{rd} party communication system utilizes the same network as the network used by the transaction metering system to communicate with the service provider computer and the customer computer. In a number of embodiments, a communication system is used that utilizes an entirely separate network to the network used by the transaction metering system to communicate with the service provider computer and the customer computer. An embodiment of a transaction system that utilizes the public switched telephone network (PSTN) as a communication network and a data network, such as the Internet, to exchange data between a service provider, a customer and a transaction metering system is shown in FIG. 10. The transaction system 10′ includes a transaction metering system 12′ connected to a service provider computer 14a and a customer computer 16a via a network 18a. The transaction metering system is also connected to a database 19′ and to a billing system 20′ via the network 18a. The transaction system 10′ further includes a service provider telephone handset 14b and a customer telephone handset 16b that are connected via the PSTN.

In the illustrated embodiment, the service provider and the customer use the PSTN to communicate with each other and use the Internet to communicate with the transaction metering system. In other embodiments, the transaction metering system can coordinate communication that occurs on the separate network. For example, the transaction metering system can reserve a conference call number where the services are provided on a one-to-many basis or establish a double blind call between the service provider and the customer where services are provided on a one-to-one basis. In other embodiments, other communication networks can be used in conjunction with a transaction metering system and the extent to which the transaction metering system coordinates the communication is dependent upon the application.

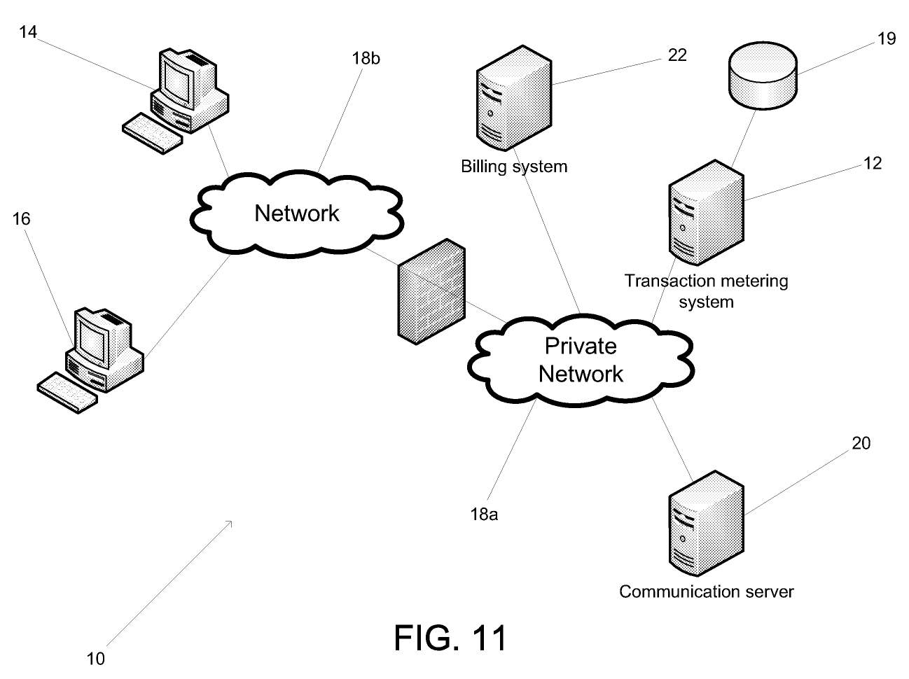

A transaction system in accordance with another embodiment of the invention is shown in FIG. 11. The transaction system 10″ includes an integrated transaction metering system 12″, a billing system 20″ and a communication system 22″. The transaction metering system 12″, a billing system 20″ and a communication system 22″ are all connected via a private network 18a″ that bridges to the Internet 18b″ via a Firewall. In the illustrated embodiment, a single entity provides the communication mechanism, the rate negotiation, the metering, the billing and the record of the transaction. The integration of each of the systems means that actions such as metering and billing can be automatically initiated based upon the actions of other systems. In many embodiments, the specific actions performed depend upon the requirements of the transaction.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A transaction system, comprising:
a transaction metering system connected to a service provider computing device and a client computing device via a first communication network;
wherein the service provider computing device and the client computing device are connected via a second communication network;
wherein the service provider computing device and the client computing device are configured to negotiate terms for the completion of a transaction by exchanging messages over the first communication network via the transaction metering system;
wherein the service provider computing device and the client computing device are configured to conduct a communication session via the second communication network; and
wherein the transaction metering system is configured to meter a transaction conducted during a communication session.

2. The transaction system of claim 1, wherein the service provider computing device and the customer computing device are personal computers including appropriately configured client applications.

3. The transaction system of claim 1, wherein the service provider computing device and the customer computing device are devices configured using appropriate web browsing applications.

4. The transaction system of claim 1, wherein the first communication network includes the Internet.

5. The transaction system of claim 4, wherein the second communication network includes the Internet.

6. The transaction system of claim 5, wherein the second communication network is an Instant Messaging network, a Voice over Internet Protocol network or a video conferencing network.

7. The transaction system of claim 4, wherein the second communication network is the public switched telephone network.

8. The transaction system of claim 4, wherein the second communication network is a mobile telephone network.

9. The transaction system of claim 1, wherein the transaction metering system is configured to initiate a communication session between the service provider computing device and the customer computing device.

10. The transaction system of claim 1, wherein:
the customer computing device is configured to send a signal to the transaction metering system indicative of the commencement of a transaction; and
the transaction metering system is configured to commence metering the transaction in response to receipt of the signal from the customer computing device.

11. The transaction system of claim 1, wherein:
the customer computing device is configured to provide billing information to the transaction metering system; and
the transaction metering system is configured to verify the billing information.

12. The transaction system of claim 11, wherein:
the transaction metering system is configured to provide at least some of the billing information to a billing system; and
the billing system is configured to verify the billing information and provide verification information to the transaction metering system.

13. The transaction system of claim 12, wherein:
the billing system is operated independently of the transaction metering system; and
the billing system and transaction metering system are connected via a public network.

14. The transaction system of claim 12, wherein the billing system and transaction metering system are connected via a private network.

15. The transaction system of claim 12, wherein the transaction metering system is configured to generate a risk report including at least some of the verification information.

16. The transaction system of claim 15, wherein the transaction metering system is configured to generate an image that graphically illustrates the risk of proceeding with a transaction.

17. The transaction system of claim 1, wherein:
the transaction metering system is configured to provide at least one payment option to the customer computing device;
the customer computing device is configured to communicate a payment option selection and billing information appropriate to the payment option selection to the transaction metering system;
the transaction metering system is configured to determine a transaction fee based on the negotiated terms and the metered duration of the transaction;
the transaction metering system is configured to provide the transaction fee and the billing information to a billing system; and
the billing system is configured to perform a funds transfer in the amount of the transaction fee in the manner indicated by the selected payment option.

18. The transaction system of claim 17, wherein the transaction metering system is configured to generate a transaction record.

19. The transaction system of claim 18, wherein the transaction metering system is configured to store the transaction record in a database.

20. The transaction system of claim 18, wherein the transaction metering system is configured to send copies of the transaction record to the customer computer and to the service provider computer.

21. A method of conducting a transaction, comprising:
logging into a server;
negotiating terms of service by transferring messages via the server;
providing billing information to the server;
verifying the billing information;
initiating the metering of the transaction by providing a message to the server;
stopping the metering of the transaction by providing a message to the server;
performing a funds transfer using the billing information for an amount determined in accordance with the terms of service and the metered time of the transaction;
generating a record of the transaction;
distributing the record to the parties to the transaction; and
storing a copy of the transaction.

22. The method of claim 21, further comprising:
displaying risk information; and
accepting the risk of the transaction by communicating an instruction to proceed to the server.

23. The method of claim 21, further comprising initiating a communication session involving exchange of data via a second server that is independent of the first server.

24. A server configured to facilitate a transaction, comprising:
a server configured to connect to a network;
wherein the server is configured to receive messages concerning terms of service via the network connection;
wherein the server is configured to forward messages concerning terms of service via the network connection;
wherein the server is configured to receive messages accepting terms of service via the network connection;
wherein the server is configured to provide information concerning payment options via the network connection;
wherein the server is configured to receive a message including the selection of a payment option via the network connection;
wherein the server is configured to receive a message containing payment information via the network connection;
wherein the server is configured to validate at least some of the payment information;
wherein the server is configured to forward at least some of the payment information to a billing system;
wherein the server is configured to receive a message including validation information from the billing system;
wherein the server is configured to provide validation information via the network connection;
wherein the server is configured to receive a message authorizing proceeding with the transaction via the network connection;
wherein the server is configured to receive a message authorizing metering of the transaction via the network connection;
wherein the server is configured to provide information concerning the meter via the network connection;
wherein the server is configured to receive a message including instructions to stop the meter via the network connection;
wherein the server is configured to calculate a transaction fee;
wherein the server is configured to send a message containing the transaction fee and at least some of the billing information to the billing system;
wherein the server is configured to generate a transaction record; and
wherein the server is configured to provide the transaction record via the network connection.
